(19) United States
(12) Patent Application Publication
(10) Pub. No.: US 2024/0167828 A1
(43) Pub. Date: May 23, 2024

(54) INFORMATION DISPLAY DEVICE

(71) Applicant: TOYOTA JIDOSHA KABUSHIKI KAISHA, Toyota-shi Aichi-ken (JP)

(72) Inventors: Yoshie SAKAKIBARA, Okazaki-shi Aichi-ken (JP); Kazuhiro NISHIMURA, Suntou-gun Shizuoka-ken (JP); Hirotaka NOGAMI, Nisshin-shi Aichi-ken (JP); Makoto TAMURA, Miyoshi-shi Aichi-ken (JP); Toyokazu NAKASHIMA, Nagoya-shi Aichi-ken (JP); Daigo ICHIKAWA, Nisshin-shi Aichi-ken (JP); Shintaro MATSUTANI, Kariya-shi Aichi-ken (JP)

(73) Assignee: TOYOTA JIDOSHA KABUSHIKI KAISHA, Toyota-shi Aichi-ken (JP)

(21) Appl. No.: 18/378,685

(22) Filed: Oct. 11, 2023

(30) Foreign Application Priority Data
Nov. 18, 2022 (JP) 2022-184981

(51) Int. Cl. G01C 21/34; G01C 21/36; G06V 20/13

(52) U.S. Cl. CPC G01C 21/3461; G01C 21/3676; G06V 20/13

(57) ABSTRACT

An information display device is provided, which includes at least one processor, the at least one processor being configured to: acquire disaster information corresponding to a current position of a vehicle; generate a first image displaying the current position of the vehicle on a narrow-area map of vehicle surroundings; generate a second image displaying an entirety of a disaster-stricken area identified from the disaster information and the current position of the vehicle on a wide-area map of vehicle surroundings; and effect adjacent display of the first image and the second image at a display unit provided inside a vehicle cabin.

### CROSS-REFERENCE TO RELATED APPLICATION

This application is based on and claims priority under 35 USC 119 from Japanese Patent Application No. 2022-184981 filed on Nov. 18, 2022, the disclosure of which is incorporated by reference herein.

### BACKGROUND

### Technical Field

The present disclosure relates to an information display device and an information display method.

### Related Art

Japanese Patent Application Laid-open (JP-A) No. 2020-088741 discloses an onboard information terminal that, when a disaster crisis report has been received, informs a user of information relating to a place in which a disaster has occurred, using a vehicle position as a reference. This document proposes displaying the vehicle position and the orientation of the disaster area relative to the vehicle position on a map displayed on a display (see FIG. 6 of JP-A No. 2020-088741). Further, this document proposes highlighting the vehicle position and a target area of the disaster area on the map displayed on the display (see FIG. 9 of JP-A No. 2020-088741).

In the technique described in JP-A No. 2020-088741, displaying the vehicle position and the orientation of the disaster area based on the vehicle position on the map serves as a deterrent to prevent the vehicle from being directed to the disaster area.

However, with simply the orientation of the disaster area being displayed, it is difficult for the user to grasp the scale of the disaster. Moreover, displaying the target area of the disaster area on the map means that in a case in which the target area is wide, the scale of the map decreases, and it is difficult to understand the roads around the vehicle. Accordingly, there is room for improvement regarding guidance concerning the scale of the disaster area and the road information around the vehicle in the technology described in the above-noted JP-A No. 2020-088741.

### SUMMARY

In consideration of the above facts, an object of the present disclosure is to provide an information display device and an information display method capable of guidance concerning the size of a disaster-stricken area and road information for the vehicle surroundings.

An information display device according to a first aspect of the present disclosure includes: an acquisition unit that acquires disaster information corresponding to a current position of a vehicle; a first image generation unit that generates a first image displaying the current position of the vehicle on a narrow-area map of vehicle surroundings; a second image generation unit that generates a second image displaying an entirety of a disaster-stricken area identified from the disaster information and the current position of the vehicle on a wide-area map of vehicle surroundings; and a display control unit that effects adjacent display of the first image and the second image at a display unit provided inside the vehicle.

In the information display device according to the first aspect of the present disclosure, disaster information corresponding to the current position of a vehicle is acquired, and a first image indicating a narrow-area map of the vehicle surroundings and a second image indicating a wide-area map of the vehicle surroundings are generated. Further, the information display device displays the first image and the second image side by side at a display unit provided inside the vehicle cabin.

Note that the first image displays the current position of the vehicle on a narrow-area map of the vehicle surroundings. Accordingly, by viewing the first image, the roads in the vehicle surroundings can be understood. On the other hand, the second image displays the entire area of a disaster-stricken area identified from the disaster information and the current position of the vehicle on a wide-area map of the vehicle surroundings. Accordingly, the scale of the disaster can be understood by viewing the second image. In this manner, the information display device can provide guidance to the user inside the vehicle cabin regarding the scale of the disaster-stricken area and road information for the vehicle surroundings.

An information display device according to a second aspect of the present disclosure is the first aspect, in which a scale of the map the first image is modifiable in accordance with a user setting, and the display control unit effects display of the first image and the second image alongside each other at the display unit in a case in which the scale of the map of the first image is set larger than a scale of the map of the second image, and effects display of only the second image at the display unit in a case in which the scale of the map of the first image is set equal to or smaller than the scale of the map of the second image.

In the information display device according to the second aspect of the present disclosure, in a case in which the scale of the map of the first image is set larger than the scale of the map of the second image, the information display device displays the first image and the second image side by side at the display unit. Namely, in a case in which the map indicated by the first image shows a narrower area than the map indicated by the second image in an enlarged manner, the first image and the second image are displayed side by side on the display unit. On the other hand, in a case in which the scale of the map of the first image is set to be equal to or smaller than the scale of the map of the second image, the information display device displays only the second image on the display unit. Namely, in a case in which the map indicated by the first image and the map indicated by the second image indicate the same region, or in a case in which the map represented by the first image is shown with a larger area than the map represented by the second image, the two images are integrated and only the second image displayed. As described above, in the information display device, based on the scale of the map, in a case in which it is determined that the first image displays more detail of the vehicle surroundings than the second image, the first image is displayed side by side with the second image, and if not, the two images are integrated and only the second image is displayed. This enables the information amount of the display unit when traveling in the vicinity of the disaster-stricken region to be optimized in accordance with the settings of the user.

An information display device according to a third aspect of the present disclosure is the first aspect or second aspect, in which the display control unit effects display of only the first image at the display unit in a case in which the current position of the vehicle is outside the disaster-stricken area and removed from the disaster-stricken area by at least a predetermined distance.

In the information display device according to the third aspect of the present disclosure, in a case in which the current position of the vehicle is outside the disaster-stricken area and at least a predetermined distance from the disaster-stricken area, only the first image is displayed on the display unit. As a result, in a state in which the vehicle is removed from the disaster-stricken area and the safety of the user is secured, for example, the two images are integrated and only the first image is displayed. This enables the information amount of the display unit to be optimized when traveling at a point sufficiently distant from the disaster-stricken area.

An information display device according to a fourth aspect of the present disclosure is the configuration of the first aspect or the second aspect, further including a route proposal unit that proposes a route from the current position of the vehicle to a destination, in which the route proposal unit sets a second point outside the disaster-stricken area as a new destination candidate in a case in which a destination of the vehicle is set at a first point that is inside the disaster-stricken area, and the display control unit effects display of a route to the second point in the first image and in the second image.

In the information display device according to the fourth aspect of the present disclosure, the travel route of the vehicle can be proposed by displaying a route from the current position of the vehicle to the destination on the display unit. Note that in the information display device, in a case in which the destination of the vehicle is set to a first point inside the disaster-stricken area, a second point outside the disaster-stricken area is set as a new destination candidate. The information display device then displays the route to the second point on the first image and the second image. This enables a vehicle heading to a destination inside the disaster-stricken area to be guided with respect to a route to a destination candidate outside the disaster-stricken area, and therefore, guidance regarding an evacuation route corresponding to the current position of the vehicle can be provided to a vehicle in the vicinity of a disaster-stricken area.

An information display device according to a fifth aspect of the present disclosure is the configuration of the first aspect or the second aspect, in which the disaster information includes a satellite image of ground level captured by an artificial satellite, and the disaster-stricken area is identified based on the satellite image.

In the information display device according to the fifth aspect of the present disclosure, the disaster-stricken area is identified based on a satellite image of ground level captured by an artificial satellite. As a result, even at times when detailed information relating to a disaster-stricken area is not available from public organizations, by viewing an area based on disaster information from overhead, it is possible to quickly provide guidance regarding the scale of the disaster-stricken area and road information for the vehicle surroundings.

As described above, the information display device according to the present disclosure can provide guidance regarding the size of the disaster-stricken area and road information for the vehicle surroundings.

### BRIEF DESCRIPTION OF THE DRAWINGS

Exemplary embodiments of the present disclosure will be described in detail based on the following figures, wherein:

FIG. 1 is a diagram illustrating a schematic configuration of a system configured by an information display device according to the present exemplary embodiment;

FIG. 2 is a block diagram illustrating a hardware configuration of an information display device;

FIG. 3 is a block diagram illustrating an exemplary functional configuration of an information display device;

FIG. 4 is an example of a first image and a second image displayed at a display unit;

FIG. 5 is an example of a first image and a second image displayed at a display unit;

FIG. 6 is a flow chart illustrating a flow of image display processing; and

FIG. 7 is a flow chart illustrating a flow of route display processing for a route illustrated in FIG. 4.

### DETAILED DESCRIPTION

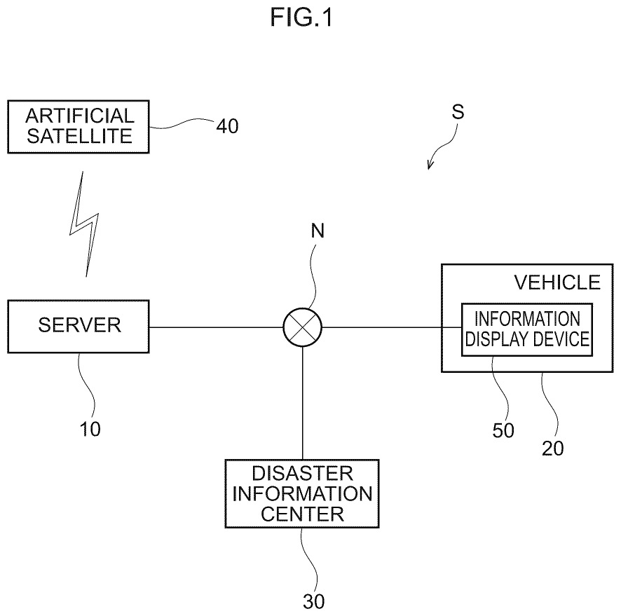

Explanation follows regarding a system S according to the present exemplary embodiment, with reference to FIGS. 1 to 7. The system S according to the present exemplary embodiment is a system that provides guidance to a user inside a vehicle cabin regarding the scale of a disaster area and road information in the vehicle surroundings.

As illustrated in FIG. 1, the system S includes a server 10, a vehicle 20, a disaster information center 30, and an artificial satellite 40. In the system S, the server 10, the vehicle 20, and the disaster information center 30 are connected through a network N.

The server 10 is a server computer that acquires an image (hereafter also referred to as a “satellite image”) captured by the satellite 40, from the satellite 40. Note that the satellite image may be, for example, an image in which a range from 0.5 km to 20 km square at ground level is set as a capture target. Moreover, the server 10 acquires disaster information transmitted from the disaster information center 30.

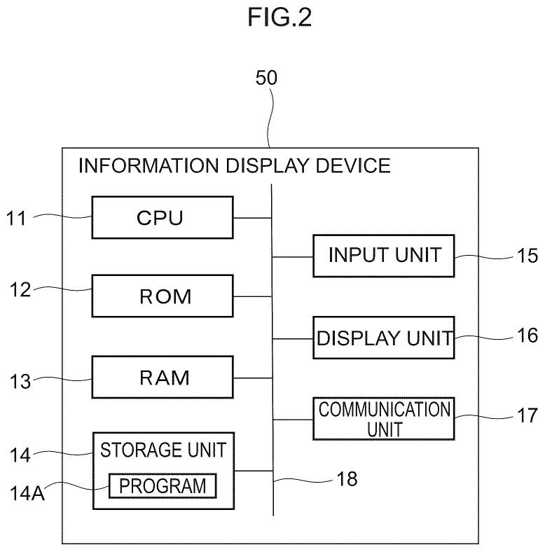

The vehicle 20 includes an information display device 50 connected to the server 10 through the network N. The information display device 50 acquires a satellite image and disaster information from the server 10, and displays an image generated based on the acquired information at a display unit 16 (see FIG. 2). Although FIG. 1 illustrates only one vehicle 20, in actuality, the information display devices 50 of plural vehicles 20 are connected through the network N.

The disaster information center 30 is a public organization that distributes disaster information indicating disaster areas, disaster situations, and the like when a disaster has occurred, via a wide area communication network.

The artificial satellite 40 orbits on the earth's satellite orbit at a predetermined cycle and captures images of ground level. The number of times that the artificial satellite 40 orbits the Earth on a day, the altitude of the orbit of the artificial satellite 40, and the like are arbitrary. Although FIG. 1 illustrates only one artificial satellite 40, the artificial satellite 40 is preferably configured by plural artificial satellites capable of capturing the same point at ground level.

Explanation follows regarding a hardware configuration of the information display device 50. FIG. 2 is a block diagram illustrating a hardware configuration of the information display device 50.

As illustrated in FIG. 2, the information display device 50 includes a central processing unit (CPU) 11, read only memory (ROM) 12, random access memory (RAM) 13, a storage unit 14, an input unit 15, a display unit 16, and a communication unit 17. These configurations are connected together through a bus 18 so as to be capable of communicating with each other.

The CPU 11 is a central processing unit that executes various programs and controls various units. The CPU 11 reads a program from the ROM 12 or the storage unit 14, and executes the program using the RAM 13 as a workspace. The CPU 11 controls the respective configurations and performs various computation processing according to a program stored in the ROM 12 or the storage unit 14.

The ROM 12 holds various programs and various data. The RAM 13 serves as a workspace to temporarily store programs and data.

The storage unit 14 is configured by a storage device such as a hard disk drive (HDD), a solid state drive (SSD), or flash memory, and holds various programs and various data. The storage unit 14 holds a program 14A for causing the CPU 11 to execute image display processing and route display processing, described below.

The input unit 15 includes operation switches, a microphone, a camera, and the like provided inside the vehicle cabin of the vehicle 20, and is used to perform various inputs.

The display unit 16 is, for example, a liquid crystal display provided inside the vehicle cabin, and is preferably configured by a display provided on an instrument panel at a front side of the driver's seat. The display unit 16 displays various information to a user inside the vehicle cabin. The display unit 16 may employ a touch panel method to function as the input unit 15.

The communication unit 17 is an interface for communicating with other devices. For example, a wired communication standard such as Ethernet (registered trademark) or FDDI, or a wireless communication standard such as 4G, 5G, Bluetooth (registered trademark), or Wi-Fi (registered trademark) is used for this communication. The communication unit 17 is connected to the network N.

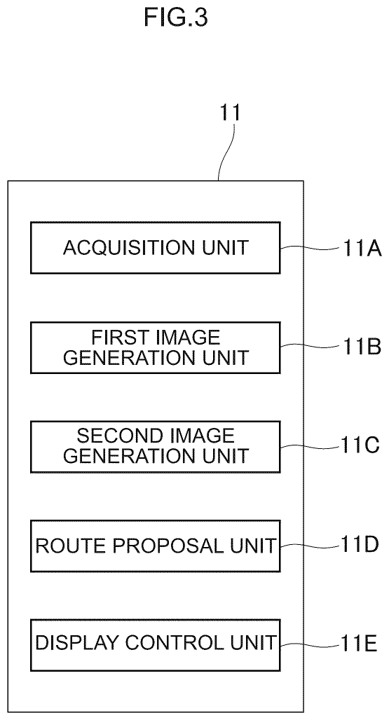

Next, explanation follows regarding functional configuration of the information display device 50. FIG. 3 is a first block diagram illustrating an example of functional configuration of the information display device 50. The information display device 50 is configured including, as functional configuration, an acquisition unit 11A, a first image generation unit 11B, a second image generation unit 11C, a route proposal unit 11D, and a display control unit 11E. The respective functional configuration is implemented by the CPU 11 reading and executing the program 14A stored in the ROM 12 or the storage unit 14.

The acquisition unit 11A acquires map data for the vehicle surroundings and disaster information. The map data for the vehicle surroundings is acquired from the server 10 or the like as map data relating to the surroundings of the current position of the vehicle 20 specified based on a signal from a non-illustrated global positioning system (GPS) sensor. In a case in which a high-precision map is stored in the internal storage of the vehicle 20, the acquisition unit 11A may acquire map data from the storage unit 14.

The disaster information includes information transmitted from the disaster information center 30, and information acquired from a satellite image taken by the artificial satellite 40 of ground level at the disaster-stricken area. The acquisition unit 11A acquires disaster information transmitted to a target region within a predetermined area from the vehicle 20 based on the current position of the vehicle 20. The disaster information may be acquired directly from the disaster information center 30 or may be acquired through the server 10. The disaster information includes disaster areas, disaster circumstances, and the like.

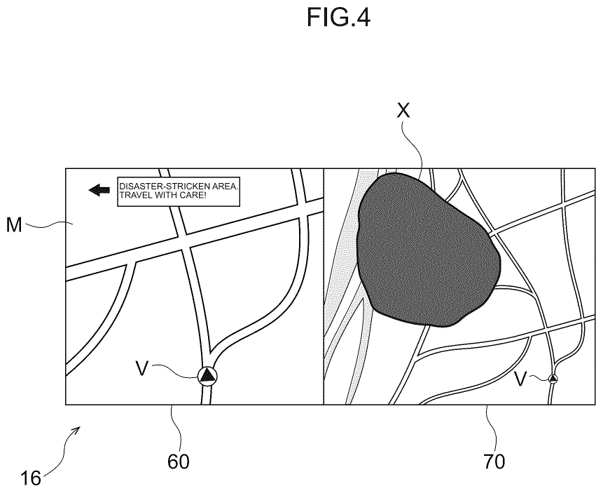

The first image generation unit 11B generates a first image. As illustrated in FIG. 4, the first image 60 is an image in which an icon V indicating the current position of the vehicle 20 is displayed on a map indicating the vehicle surroundings. Moreover, a direction M of the disaster-stricken area is illustrated at an upper portion of the first image 60. The scale of the map of the first image 60 can be changed in accordance with user settings. Accordingly, in accordance with a user setting, the map illustrated by the first image 60 can be a narrow map or a wide map.

Moreover, when the travel route of the vehicle 20 is proposed by the route proposal unit 11D, the first image generation unit 11B generates an image in which the travel route is displayed on the map of the first image.

The second image generation unit 11C generates a second image. As illustrated in FIG. 4, the second image 70 is an image in which the entire disaster-stricken area identified from the disaster information and the current position of the vehicle 20 are displayed on a wide-area map indicating the vehicle surroundings. In the example of FIG. 4, the area X indicating the entire disaster-stricken area is displayed in a different color from the other areas on the map. An icon V indicating the current position of the vehicle 20 is displayed on the map. The scale of the second image 70 is fixed according to the relative positional relationship between the size of the disaster-stricken area and the vehicle 20, and the scale of the map cannot be modified by the user.

Note that the disaster-stricken area is identified based on at least one of information transmitted from the disaster information center 30 or a satellite image captured by the satellite 40 of ground level. When identifying a disaster-stricken area using satellite images, a satellite image obtained by capturing an area designated by the disaster information center 30 as an evacuation region can be analyzed, and an area in which travel by the vehicle is difficult can be identified as a disaster-stricken area, for example. Moreover, the disaster-stricken area can be updated by comparing data acquired from satellite images in the same area in a time-sequential manner.

Moreover, when the travel route of the vehicle 20 is proposed by the route proposal unit 11D, the second image generation unit 11C generates an image in which the route is displayed on the map of the second image.

The route proposal unit 11D proposes a travel route from a current position of the vehicle 20 to a destination. More specifically, when a destination is set by the user, the route proposal unit 11D refers to the map data and identifies a travel route from the current position of the vehicle to the destination. The specified travel route is displayed on the map displayed on the display unit 16 inside the vehicle cabin.

When a disaster has occurred, in a case in which the destination of the vehicle 20 is set to a first point inside the disaster-stricken area, the route proposal unit 11D sets a second point outside the disaster-stricken area as a new destination that is a setting candidate, and proposes a route to the second point. The second point may be an evacuation location designated by the disaster information center 30, or may be a location preset by the user as an emergency evacuation location. Alternatively, the user may select a destination outside the disaster-stricken area from among previously set destinations, and set this as a destination candidate.

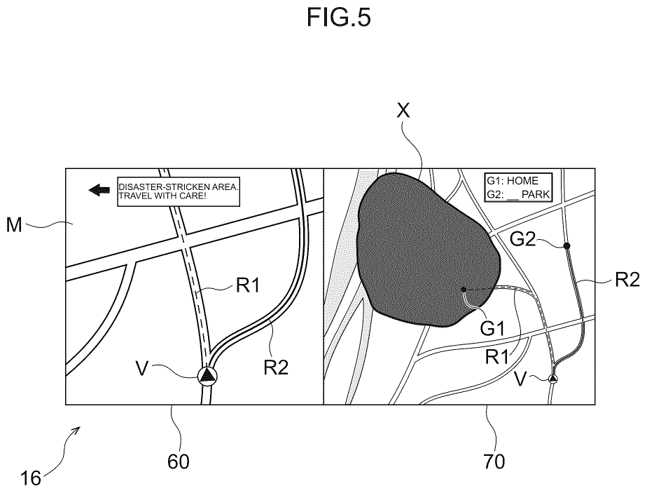

Referring to FIG. 5, a destination G1 set by the user is inside the disaster-stricken area X. For this reason, a second point G2 outside the disaster-stricken area X is set as a candidate destination, and a route R2 from the current position of the vehicle 20 to the second point G2 is displayed on the map displayed on the display unit 16. The user can compare the route R1 to the original destination G1 and the route R2 to the destination candidate G2 and consider evacuation.

The display control unit 11E controls images displayed on the display unit 16. For example, when the ignition switch of the vehicle 20 is switched ON, the display control unit 11E causes the first image to be displayed on the display unit 16. Moreover, when disaster information has been acquired, the display control unit 11E causes the second image to be displayed on the display unit 16.

Note that the display mode of the second image is changed according to the scale of the map of the first image and the scale of the map of the second image. More specifically, in a case in which the scale of the map of the first image is set larger than the scale of the map of the second image, the display unit 16 displays the second image side by side with the first image. When the scale of the map in the first image is set larger than the scale of the map in the second image, as illustrated in FIG. 4, the map illustrated by the first image 60 is illustrated in an enlarged manner over a narrower region than the map illustrated by the second image 70. Accordingly, the user can view the first image 60 and comprehend the details of the roads around the vehicle, and the second image 70 enables the scale of the disaster to be intuitively grasped.

On the other hand, in a case in which the scale of the map of the first image is set to be equal to or smaller than the scale of the map of the second image, only the second image is displayed on the display unit 16. When the scale of the map in the first image is set to be equal to or smaller than the scale of the map in the second image, the first image represents the same region as the map represented by the second image, or represents a wider area than the map represented by the second image in a scaled-down manner. In such cases, since the map information obtained from the first image and the map information obtained from the second image resemble each other, the display control unit 11E integrates the two images and displays only the second image.

Moreover, when the vehicle 20 is separated from the disaster-stricken area and safety is secured, only the first image is displayed on the display unit 16. More specifically, in cases in which the position of the vehicle 20 is outside the disaster-stricken area and away from the disaster-stricken area by a predetermined distance or more, only the first image is displayed.

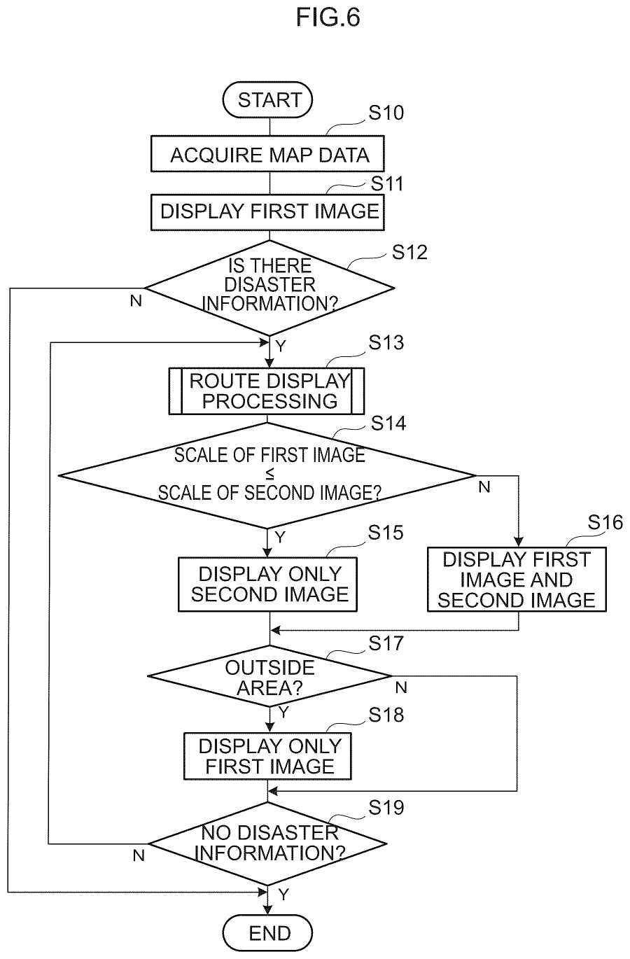

Image Display Processing FIG. 6 is a flowchart illustrating a flow of image display processing in which the information display device 50 provides guidance to a user regarding the scale of a disaster-stricken area and road information for the vehicle surroundings. As an example, when the ignition switch of the vehicle 20 is switched ON, image display processing is performed. The image display processing is performed by the CPU 11 reading the program 14A from the storage unit 14, and expanding and executing the program 14A in the RAM 13.

At step S10 illustrated in FIG. 6, the CPU 11 acquires map data for the vehicle surroundings using the functionality of the acquisition unit 11A. The CPU 11 then proceeds to the processing of step S11.

At step S11, the CPU 11 displays only the first image on the display unit 16. At this time, in a case in which the user sets the destination of the vehicle 20, the route to the destination proposed by the route proposal unit 1 ID is displayed on the map of the first image. The CPU 11 then proceeds to the processing of step S12.

At step S12, the CPU 11 determines whether or not there is disaster information. In a case in which disaster information targeted at a predetermined area has been acquired based on the current position of the vehicle 20, the determination at step S12 is affirmative, and the CPU 11 proceeds to the processing at step S13. On the other hand, in a case in which disaster information targeted at the predetermined area has not been acquired, the determination at step S12 is negative, and the CPU 11 ends the image display processing.

At step S13, the CPU 11 executes route display processing. This route display processing is described later. Then, the CPU 11 proceeds to the processing of step S14.

At step S14, the CPU 11 determines whether or not the scale of the first image is set to be equal to or smaller than the scale of the second image. Namely, the determination of step S14 is affirmative in a case in which the first image shows the same region as the map indicated by the second image or shows a larger area than the map indicated by the second image in a reduced size. In a case in which the determination of step S14 is affirmative, the CPU 11 proceeds to the processing of step S15. On the other hand, in a case in which the first image shows a narrower region than the map shown by the second image in an enlarged manner, the determination at step S14 is negative, and the CPU 11 proceeds to the processing of step S16.

At step S15, the CPU 11 displays only the second image on the display unit 16. Then, the CPU 11 proceeds to the processing of step S17.

At step S16, the CPU 11 displays the first image 60 and the second image 70 side by side on the display unit. Then, the CPU 11 proceeds to the processing of step S17.

At step S17, the CPU 11 determines whether or not the current position of the vehicle 20 is outside the disaster-stricken area. More specifically, in a case in which the current position of the vehicle 20 is outside the disaster-stricken area and removed from the disaster-stricken area by a predetermined distance or more, the determination of step S17 is affirmative. In a case in which the determination of step S17 is affirmative, the CPU 11 proceeds to the processing of step S18. On the other hand, in a case in which the current position of the vehicle 20 is less than a predetermined distance from the disaster-stricken area, the determination at step S17 is negative, and the CPU 11 proceeds to the processing at step S19.

At step S18, the CPU 11 displays only the first image on the display unit 16. The CPU 11 then proceeds to the processing of step S19.

At step S19, the CPU 11 determines whether or not there is disaster information. In a case in which the disaster information targeted at the predetermined area is not acquired based on the current position of the vehicle 20, the determination of step S19 is affirmative. In a case in which the determination at step S19 is affirmative, the CPU 11 ends the image display processing. On the other hand, in a case in which the determination of step S19 is negative, the CPU 11 returns to the processing of step S13.

Route Display Processing

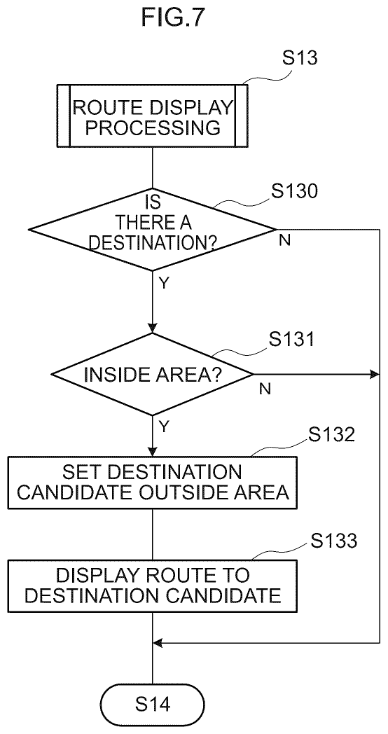

Next, explanation follows regarding route display processing in which the information display device 50 guides a user regarding a route to a destination candidate outside the disaster-stricken area, with reference to FIG. 7.

At step S130 illustrated in FIG. 7, the CPU 11 determines whether or not the destination of the vehicle 20 has been set. In a case in which the destination of the vehicle 20 has been set, the determination of step S130 is affirmative, and the CPU 11 proceeds to the processing of step S131. On the other hand, in a case in which the destination of the vehicle 20 has not been set, the determination at step S130 is negative, and the CPU 11 ends the route display processing.

At step S131, the CPU 11 determines whether or not the destination of the vehicle 20 is inside the disaster-stricken area. As illustrated in FIG. 5, in a case in which the destination of the vehicle 20 is the first point G1 inside the disaster-stricken area, the determination of step S131 is affirmative, and the CPU 11 proceeds to the processing of step S132. On the other hand, in a case in which the destination of the vehicle 20 is a point outside the disaster-stricken area, the determination at step S131 is negative, and the CPU 11 ends the route display processing.

At step S132, the CPU 11 sets a second point outside the disaster-stricken area as a destination candidate. The CPU 11 then proceeds to the processing of step S133.

At step S133, the CPU 11 causes the display unit 16 to display the route to the second point set as the destination candidate. As illustrated in FIG. 5, the route R2 to the second point G2 is displayed on the first image 60 and the second image 70, together with the route R1 to the destination G1 within the disaster-stricken area. Then, the CPU 11 ends the route display processing.

Mechanism and Effects

As described above, in the information display device 50 according to the present exemplary embodiment, disaster information corresponding to the current position of the vehicle 20 is acquired, and a first image indicating a map of the vehicle surroundings and a second image indicating a wide-area map of the vehicle surroundings are generated. The information display device 50 then displays the first image and the second image side by side on the display unit 16 provided inside the vehicle cabin under predetermined conditions.

More specifically, in a case in which the scale of the map of the first image is set larger than the scale of the map of the second image according to a setting by the user, the information display device 50 displays the first image and the second image side by side on the display unit 16. In this state, as illustrated in FIG. 4, the map illustrated in the first image 60 is illustrated in an enlarged manner over a narrower region than the map illustrated in the second image 70. Accordingly, the user can comprehend the roads around the vehicle in detail by looking at the first image 60.

On the other hand, in a case in which the scale of the map in the first image is set to be equal to or smaller than the scale of the map in the second image, the information display device 50 displays only the second image on the display unit 16. In this state, since the first image shows the same area as the map indicated by the second image, or the first image shows a wider area than the map indicated by the second image, the two images are integrated and only the second image displayed.

As described above, in the information display device 50, in a case in which, based on the scale of the map, it is determined that the first image 60 displays more detail of the vehicle surroundings than the second image 70, the second image 70 is displayed side by side with the first image 60, and if not, the two images are integrated and only the second image 70 displayed. This enables the information amount of the display unit 16 when traveling in the vicinity of a disaster-stricken region to be optimized in accordance with the settings of the user.

Moreover, in the information display device, in a case in which the current position of the vehicle 20 is outside the disaster-stricken area and removed from the disaster-stricken area by a predetermined distance or more, only the first image is displayed on the display unit. As a result, in a state in which the vehicle is removed from the disaster-stricken area and the safety of the user is secured, for example, the two images are integrated and only the first image is displayed. This enables the information amount of the display unit to be optimized when traveling at a point sufficiently distant from the disaster-stricken area.

In a case in which the destination of the vehicle 20 is set to a first point inside the disaster-stricken area, the information display device 50 sets a second point outside the disaster-stricken area as a new destination candidate. As illustrated in FIG. 5, the information display device 50 displays the route R2 to the second point G2 on the first image 60 and the second image 70. This enables guidance regarding the route to the destination candidate G2 outside the disaster-stricken area X to be provided to the vehicle 20 heading toward the destination G1 inside the disaster-stricken area X, and therefore, guidance regarding an evacuation route corresponding to the current position of the vehicle can be provided to a vehicle in the vicinity of a disaster-stricken area.

Note that in the above exemplary embodiment, the disaster-stricken area X displayed in the second image 70 can be specified based on a satellite image captured by the artificial satellite 40 of ground level. As a result, even at times when detailed information relating to a disaster-stricken area is not available from public organizations, by viewing an area based on disaster information from overhead, it is possible to quickly provide guidance regarding the scale of the disaster-stricken area and road information for the vehicle surroundings.

Although the information display device 50 is installed in the vehicle 20, there is no limitation thereto. The information display device may be configured by a user terminal that is separable from the vehicle 20, such as a smartphone or tablet. In this case, the user terminal is installed at a front side of the vehicle cabin for use.

Moreover, the image display processing and the route display processing executed by the CPU 11 reading and executing software (a program) in the above exemplary embodiments may be executed by various types of processor other than a CPU. Such processors include PLDs that allow circuit configuration to be modified post-manufacture, such as FPGAs, and dedicated electric circuits, these being processors including circuit configuration custom-designed to execute specific processing, such as ASICs. The provided processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although explanation has been given regarding an example in which the program 14A is stored (installed) in advance in the storage unit 14, there is no limitation thereto. The program 14A may be provided in a format recorded on a non-transitory recording medium such as a compact disc (CD), a digital versatile disc (DVD), or universal serial bus (USB) memory. Alternatively, the program 14A may be provided in a format downloadable from an external device over the network N.

What is claimed is:

1. An information display device, comprising at least one processor, the at least one processor being configured to:
acquire disaster information corresponding to a current position of a vehicle;
generate a first image displaying the current position of the vehicle on a narrow-area map of vehicle surroundings;
generate a second image displaying an entirety of a disaster-stricken area identified from the disaster information and the current position of the vehicle on a wide-area map of vehicle surroundings; and
effect adjacent display of the first image and the second image at a display unit provided inside a vehicle cabin.

2. The information display device of claim 1, wherein:
a scale of the map the first image is modifiable in accordance with a user setting, and
the at least one processor:
effects display of the first image and the second image alongside each other at the display unit in a case in which the scale of the map of the first image is set larger than a scale of the map of the second image, and
effects display of only the second image at the display unit in a case in which the scale of the map of the first image is set equal to or smaller than the scale of the map of the second image

3. The information display device of claim 1, wherein the at least one processor effects display of only the first image at the display unit in a case in which the current position of the vehicle is outside the disaster-stricken area and removed from the disaster-stricken area by at least a predetermined distance.

4. The information display device of claim 1, wherein the at least one processor is further configured to:
propose a route from the current position of the vehicle to a destination,
set a second point outside the disaster-stricken area as a new destination candidate in a case in which a destination of the vehicle is set at a first point that is inside the disaster-stricken area, and
effect display of a route to the second point in the first image and in the second image.

5. The information display device of claim 1, wherein:
the disaster information includes a satellite image of ground level captured by an artificial satellite, and
the at least one processor is configured to identify the disaster-stricken area based on the satellite image.

6. An information display method, comprising:
acquiring disaster information corresponding to a current position of a vehicle;
generating a first image displaying the current position of the vehicle on a narrow-area map of vehicle surroundings;
generating a second image displaying an entirety of a disaster-stricken area identified from the disaster information and the current position of the vehicle on a wide-area map of vehicle surroundings; and
effecting adjacent display of the first image and the second image at a display unit provided inside the vehicle.
